(19) United States
(12) Patent Application Publication
(10) Pub. No.: US 2018/0246569 A1
(43) Pub. Date: Aug. 30, 2018

(54) INFORMATION PROCESSING APPARATUS AND METHOD AND NON-TRANSITORY COMPUTER READABLE MEDIUM

(71) Applicant: FUJI XEROX CO., LTD., Tokyo (JP)

(72) Inventors: Takamasa ARAKAWA, Kanagawa (JP); Jiahao DAI, Kanagawa (JP)

(73) Assignee: FUJI XEROX CO., LTD., Tokyo (JP)

(21) Appl. No.: 15/688,248

(22) Filed: Aug. 28, 2017

(30) Foreign Application Priority Data
Feb. 27, 2017 (JP) 2017-034490

(51) Int. Cl. G06F 3/01; G06F 17/24; G10L 15/18; G06F 3/0484

(52) U.S. Cl. CPC G06F 3/013; G06F 3/0484; G10L 15/18; G06F 17/241

(57) ABSTRACT

An information processing apparatus includes a matching unit and a generator. The matching unit matches a position of eye gaze of a user within a document to voice output from the user viewing the document at the position of eye gaze. The generator generates an annotation to be appended to a portion of the document located at the position of eye gaze. The annotation indicates the content of the voice.

### CROSS-REFERENCE TO RELATED APPLICATIONS

This application is based on and claims priority under 35 USC 119 from Japanese Patent Application No. 2017-034490 filed Feb. 27, 2017.

### BACKGROUND

### Technical Field

The present invention relates to an information processing apparatus and method and a non-transitory computer readable medium.

### SUMMARY

According to an aspect of the invention, there is provided an information processing apparatus including a matching unit and a generator. The matching unit matches a position of eye gaze of a user within a document to voice output from the user viewing the document at the position of eye gaze. The generator generates an annotation to be appended to a portion of the document located at the position of eye gaze. The annotation indicates the content of the voice.

### BRIEF DESCRIPTION OF THE DRAWINGS

An exemplary embodiment of the present invention will be described in detail based on the following figures, wherein:

FIG. 1 is a block diagram of conceptual modules forming an example of the configuration of the exemplary embodiment (annotation generation processing apparatus);

FIG. 2 is a block diagram of conceptual modules forming an example of the configuration of the exemplary embodiment (document output apparatus);

FIG. 3 illustrates an example of a system configuration utilizing the exemplary embodiment;

FIG. 4 is a flowchart illustrating an example of processing executed in the exemplary embodiment;

FIG. 5 illustrates an example of the data structure of an eye-gaze information table;

FIG. 6 illustrates an example of the data structure of a remark information table;

FIG. 7 illustrates an example of the data structure of an annotation information table;

FIG. 8 illustrates an example of the data structure of a document object display position information table;

FIG. 9 is a flowchart illustrating an example of processing executed in the exemplary embodiment;

FIG. 10 illustrates a screen for explaining an example of processing executed in the exemplary embodiment;

FIG. 11 illustrates an example of the data structure of an annotation information table;

FIG. 12 illustrates a screen for explaining an example of processing executed in the exemplary embodiment; and

FIG. 13 is a block diagram illustrating an example of the hardware configuration of a computer implementing the exemplary embodiment.

### DETAILED DESCRIPTION

An exemplary embodiment of the invention will be described below with reference to the accompanying drawings.

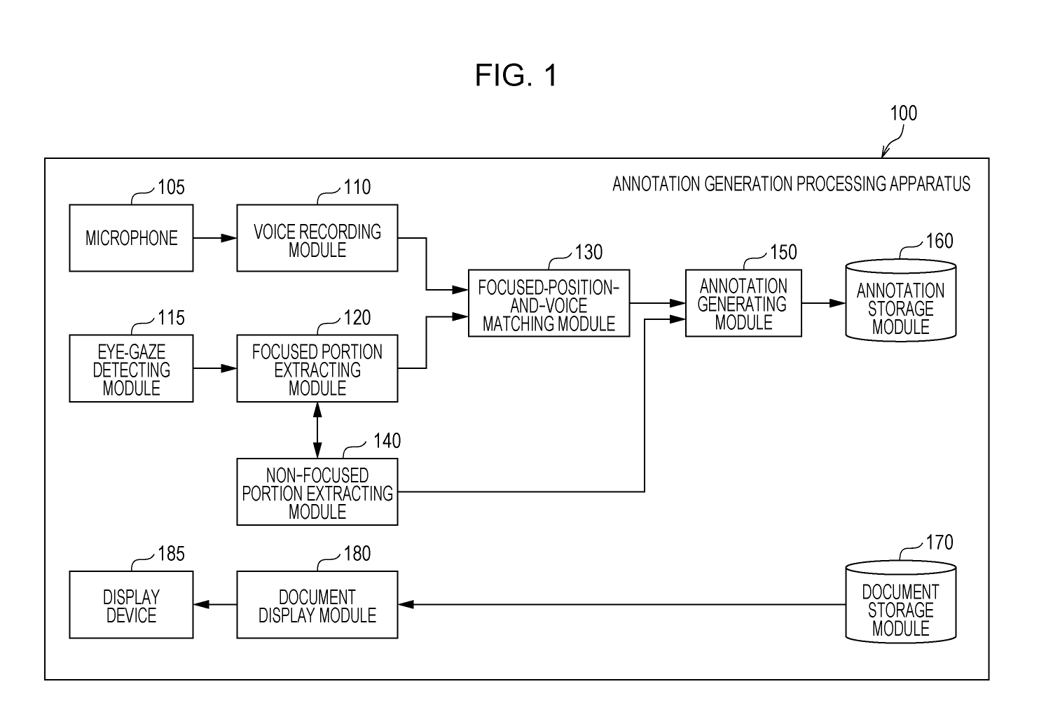

FIG. 1 is a block diagram of conceptual modules forming an example of the configuration of the exemplary embodiment (annotation generation processing apparatus 100).

Generally, modules are software (computer programs) components or hardware components that can be logically separated from one another. The modules of the exemplary embodiment of the invention are, not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, or a program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program will be stored in a storage device. Modules may correspond to functions based on a one-to-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is unnecessary. If elements are enumerated, such as “A, B, and C”, they are only examples unless otherwise stated, and such enumeration includes the meaning that only one of them (only the element A, for example) is selected.

A system or an apparatus may be implemented by connecting plural computers, hardware units, devices, etc., to one another via a communication medium, such as a network (including one-to-one communication connection), or may be implemented by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processing result is written into the storage device. A description of reading from the storage device before an operation or writing into the storage device after an operation may be omitted. Examples of the storage device may be a hard disk (HD), a random access memory (RAM), an external storage medium, a storage device using a communication line, a register within a central processing unit (CPU), etc.

An annotation generation processing apparatus 100 according to the exemplary embodiment is an apparatus that appends an annotation to a document. As shown in FIG. 1, the annotation generation processing apparatus 100 includes a microphone 105, a voice recording module 110, an eye-gaze detecting module 115, a focused portion extracting module 120, a focused-position-and-voice matching module 130, a non-focused portion extracting module 140, an annotation generating module 150, an annotation storage module 160, a document storage module 170, a document display module 180, and a display device 185. An annotation refers to information added to a document, and is expressed in the form of a sticky note, an underline, or a comment. In particular, a technique for appending an annotation to a document by using a gaze point and voice will be discussed. A document (also called a digital document, a file, etc.) is text data, numeric data, graphics data, image data, video data, voice data, or a combination thereof, and is an object that may be stored, edited, and searched for, and may be shared among systems and users as an individual unit. Equivalents of the above-described data are also included in the document. More specifically, a document is a document created by a document creating program, an image read by an image reader (such as a scanner), and a web page.

Usually, when appending an annotation to a document, a user is required to specify a portion to which the annotation is appended and to input a comment into the annotation in the form of text.

The annotation generation processing apparatus 100 detects eye gaze (including gaze points) of a user viewing a document by using a device, such as a head-mounted display, and stores what the user says about this document as an annotation in association with a portion of the document being focused by the user.

The microphone 105 is connected to the voice recording module 110. The microphone 105 picks up the voice of a user viewing a document, converts the voice into digital voice information, and supplies it to the voice recording module 110. The microphone 105 may be a personal computer (PC) microphone (microphone built in a PC), for example.

The voice recording module 110 is connected to the microphone 105 and the focused-position-and-voice matching module 130. The voice recording module 110 stores voice information in a storage unit, such as a hard disk. The voice information may be stored together with the time and date at which voice is output from a user (year, month, day, hour, minute, second, millisecond, or a combination thereof). Recording user voice as an annotation makes it possible to record a user's remark about a document, which reflects the user's intuitive impression about the document.

The eye-gaze detecting module 115 is connected to the focused portion extracting module 120. The eye-gaze detecting module 115 detects eye gaze of a user viewing a document by using a camera or a head-mounted display, for example. To detect eye gaze of a user, a known eye-gaze detecting technique may be used. For example, the eye gaze position may be detected based on the positional relationship between the inner corner of the eye as a reference point and the iris as a moving point. The eye gaze position is a position on a document displayed on the display device 185. The eye gaze position is represented by XY coordinates on a document, for example.

The focused portion extracting module 120 is connected to the eye-gaze detecting module 115, the focused-position-and-voice matching module 130, and the non-focused portion extracting module 140. The focused portion extracting module 120 stores an eye gaze position on a document displayed on the display device 185 in a storage unit, such as a hard disk. The eye gaze position may be stored together with the time and date. A portion focused by a user may be specified by using a technology such as that disclosed in Japanese Unexamined Patent Application Publication No. H01-160527 or Japanese Patent No. 3689285.

The focused-position-and-voice matching module 130 is connected to the voice recording module 110, the focused portion extracting module 120, and the annotation generating module 150. The focused-position-and-voice matching module 130 matches an eye gaze position of a user within a document to voice output from the user viewing the document at this eye gaze position. More specifically, the focused-position-and-voice matching module 130 matches an eye gaze position and user voice detected at the same time and date. In this case, the focused-position-and-voice matching module 130 may match an eye gaze position and user voice detected at times different from each other within a predetermined value, as well as those detected at exactly the same time and date. The user usually says something about a certain portion of a document while looking at this portion, but may do so while looking at a different portion. The focused-position-and-voice matching module 130 may perform matching in the following manner, for example. When the user says something (outputs voice) about a certain portion of a document at a certain time for the first time, the focused-position-and-voice matching module 130 matches the eye gaze position detected at this portion and at this time to the voice. Afterwards, during a predetermined period, even if the eye gaze position slightly moves, the focused-position-and-voice matching module 130 matches the original eye gaze position to the voice. For example, if the user starts to speak while looking at the title of a document and then moves the eye gaze to a different portion, such as an author, the focused-position-and-voice matching module 130 may still match the position of the title to the voice continuing for the predetermined period. If eye gaze is not focused on any object within a document (eye gaze is focused on a blank region, for example), the predetermined period may be extended. For example, if the user starts to speak while looking at the title of a document and then moves the eye gaze to a blank region, the focused-position-and-voice matching module 130 may still match the position of the title to the voice continuing in excess of the predetermined period unless the eye gaze shifts to a different object. In this case, upon detecting that the eye gaze shifts to a different object, the focused-position-and-voice matching module 130 stops matching the position of the title to the voice, and starts to match this different object to voice subsequently output from the user.

The non-focused portion extracting module 140 is connected to the focused portion extracting module 120 and the annotation generating module 150. The non-focused portion extracting module 140 extracts a portion which has not been focused by a user (non-focused portion) when the user has stopped viewing a document. “When the user has stopped viewing a document” refers to a time point upon detecting that the user has performed an operation for showing that the user has stopped viewing a document, such as closing a document. “A non-focused portion” is a region of a document where eye gaze is not focused, and may include a region where eye gaze is focused during a period shorter than a predetermined period.

The annotation generating module 150 is connected to the focused-position-and-voice matching module 130, the non-focused portion extracting module 140, and the annotation storage module 160. The annotation generating module 150 generates an annotation (user voice matched to an eye gaze position on a document by the focused-position-and-voice matching module 130) to be appended to a portion of the document located at this eye gaze position. Appending voice to a document as an annotation enables a user to record a memo and a comment while keeping the original document. When someone views a document with an annotation, this person understands which portion within the document has been focused by a user viewing this document and what kind of comment the user has made and what kind of impression the user has had about the portion because the voice and this portion are associated with each other.

The annotation generating module 150 may append voice as an annotation to an object located at an eye gaze position. An object is a component forming a document. Examples of an object are a character string (one or more characters), a table, a drawing, and a photo. Examples of a character string are a title, a chapter, and a section. Objects may be extracted by using a structured document which distinguishes components of the document from each other with tabs or by recognizing the structure of a document (in particular, a document image read by a scanner, for example) displayed on the display device 185.

The annotation generating module 150 may generate an annotation indicating the content of voice recognition results. In this case, the annotation generating module 150 contains a voice recognition module, which may be implemented by using a known voice recognition technology. This enables a user to check the content of user voice in the environments where sound is not supposed to be output. The user can also do a search among plural annotations in text.

The annotation generating module 150 may change a predetermined word included in the voice recognition results. Changing of a word includes the meaning of deleting a word. For example, the annotation generating module 150 may generate an annotation by deleting a predetermined keyword from user voice. Using a keyword makes it possible to eliminate highly confidential information and the inappropriate content. The annotation generating module 150 may generate an annotation by converting user voice into another expression or phrase. As a result, smooth communication using annotations is achieved.

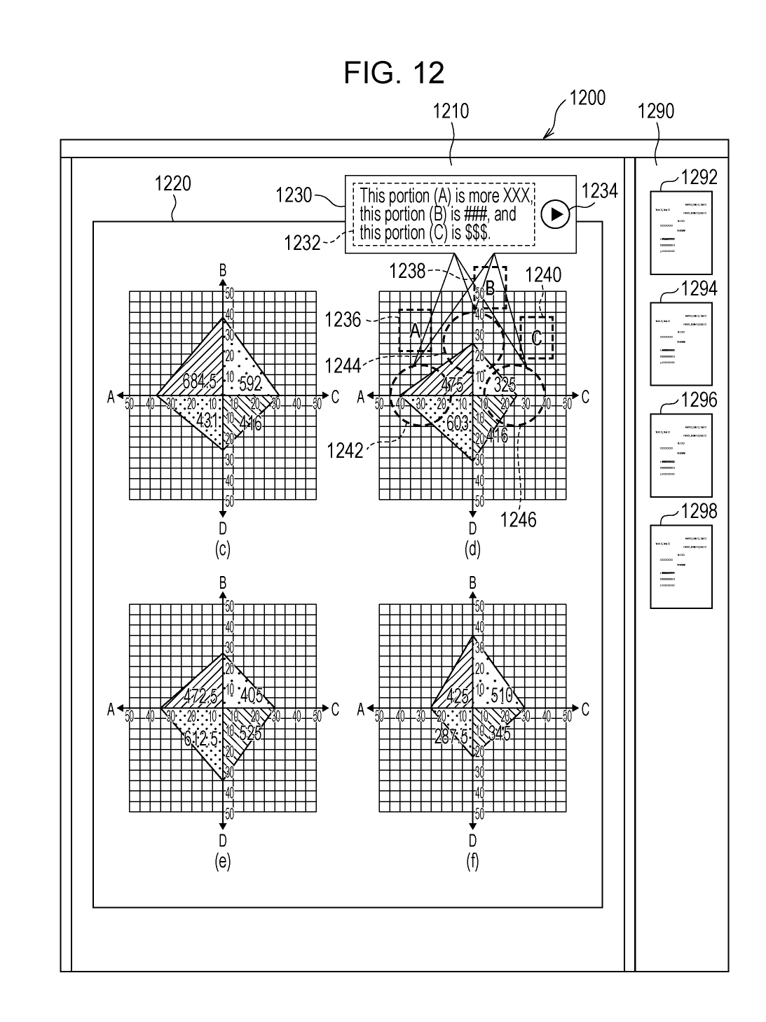

The annotation generating module 150 may generate an annotation from which a chronological change in the eye gaze position can be identified. That is, the annotation generating module 150 records a chronological change in the portion focused by a user in synchronization with user voice. This enables the user viewing a document to make natural-sounding comments for a specific portion of the document as if the user were having a face-to-face conversation. In particular, the efficiency in appending annotations to a drawing or a graph is increased, thereby further enhancing smooth communication. A display example of such annotations will be discussed later with reference to FIG. 12.

The annotation generating module 150 may generate an annotation to be appended to a portion other than eye gaze positions, as an annotation indicating that this portion is a non-focused portion. That is, a portion that has not particularly been focused by a user is recorded in a document as an annotation. Then, someone viewing the document later can recognize which portion not checked by the user, that is, which portion where editing or rewriting is not sufficiently done. As a non-focused portion, a region where eye gaze is focused during a period shorter than the predetermined period may be extracted, as well as a region where no eye gaze is focused.

The annotation generating module 150 may append an annotation to an object located at a portion other than eye gaze positions.

The annotation storage module 160 is connected to the annotation generating module 150. The annotation storage module 160 stores an annotation generated by the annotation generating module 150 in association with a document displayed on the display device 185.

The document storage module 170 is connected to the document display module 180. The document storage module 170 stores documents that may be displayed on the display device 185.

The document display module 180 is connected to the document storage module 170 and the display device 185. The document display module 180 performs control so that a document stored in the document storage module 170 will be displayed on the display device 185.

The display device 185 is connected to the document display module 180. The display device 185 displays a document on a liquid crystal display, for example, under the control of the document display module 180. Then, a user can view a document displayed on the liquid crystal display, for example.

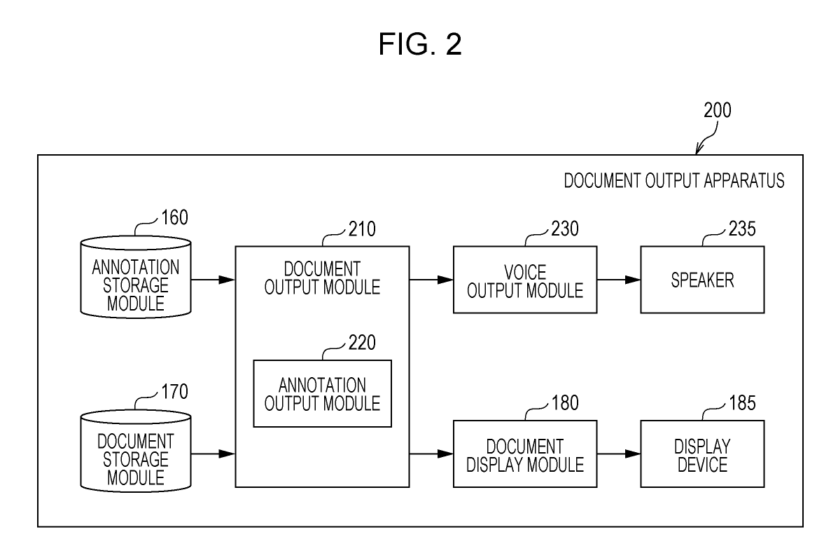

FIG. 2 is a block diagram of conceptual modules forming an example of the configuration of the exemplary embodiment (document output apparatus 200). The document output apparatus 200 displays a document appended with an annotation generated by the annotation generation processing apparatus 100. That is, the document output apparatus 200 serves as a viewer.

The document output apparatus 200 includes an annotation storage module 160, a document storage module 170, a document output module 210, a voice output module 230, a speaker 235, a document display module 180, and a display device 185.

The annotation storage module 160 is connected to the document output module 210. The annotation storage module 160 is equivalent to the annotation storage module 160 of the annotation generation processing apparatus 100, and stores annotations in association with documents.

The document storage module 170 is connected to the document output module 210. The document storage module 170 is equivalent to the document storage module 170 of the annotation generation processing apparatus 100, and stores documents that may be displayed on the display device 185.

The document output module 210 includes an annotation output module 220. The document output module 210 is connected to the annotation storage module 160, the document storage module 170, the voice output module 230, and the document display module 180. The document output module 210 displays a document appended with an annotation.

The annotation output module 220 outputs the content of an annotation according to a user operation (selecting an annotation within a document, for example).

The voice output module 230 is connected to the document output module 210 and the speaker 235. The voice output module 230 performs control so that voice contained in an annotation will be output to the speaker 235.

The speaker 235 is connected to the voice output module 230. The speaker 235 outputs voice under the control of the voice output module 230.

The document display module 180 is connected to the document output module 210 and the display device 185. The document display module 180 is equivalent to the document display module 180 of the annotation generation processing apparatus 100, and performs control so that a document stored in the document storage module 170 will be displayed on the display device 185.

The display device 185 is connected to the document display module 180. The display device 185 is equivalent to the display device 185 of the annotation generation processing apparatus 100. The display device 185 displays a document on a liquid crystal display, for example, under the control of the document display module 180. Then, a user can view a document appended with an annotation displayed on the liquid crystal display, for example.

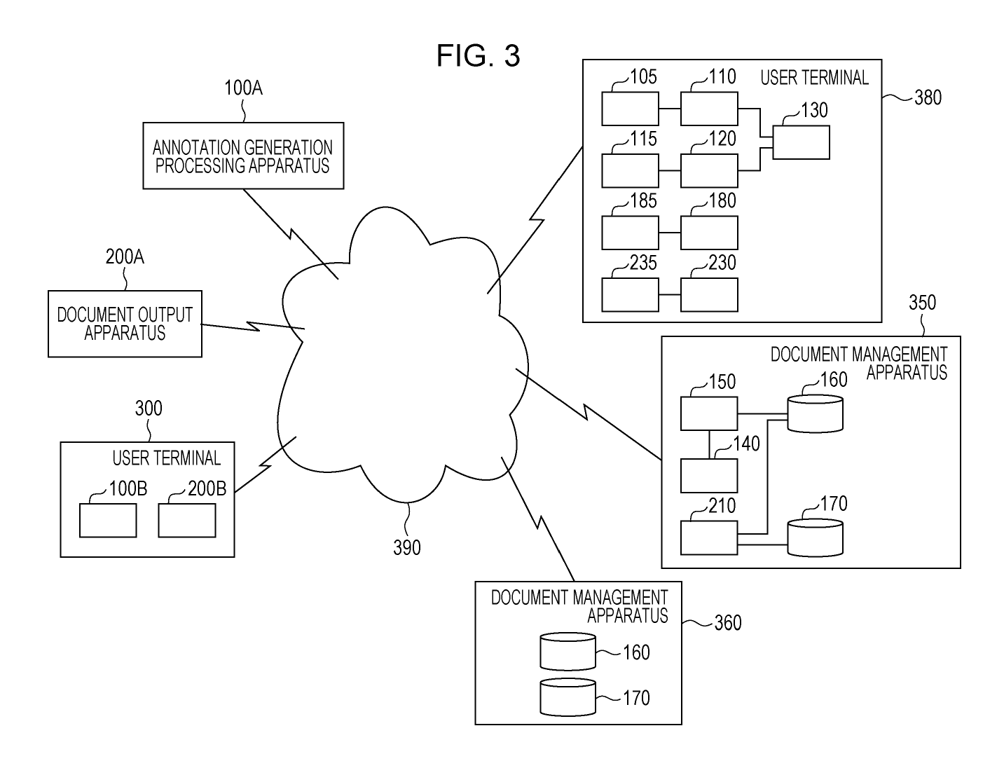

FIG. 3 illustrates an example of a system configuration utilizing this exemplary embodiment.

An annotation generation processing apparatus 100A, a document output apparatus 200A, user terminals 300 and 380, and document management apparatuses 350 and 360 are connected to each other via a communication network 390. The communication network 390 may be a wireless or wired medium or a combination thereof, and may be, for example, the Internet or an intranet as a communication infrastructure. The functions of the annotation generation processing apparatus 100A, the document output apparatus 200A, and the document management apparatuses 350 and 360 may be implemented as a cloud service.

The system shown in FIG. 3 may be used in a situation, for example, where a document created by a staff member is checked and corrected by a boss. In the annotation generation processing apparatus 100A, an annotation is appended to a document created by a staff member according to the operation of a boss. In an annotation generation processing apparatus 100B, the document appended with the annotation is displayed according to the operation of the staff member, and the staff member checks the annotation appended by the boss.

The annotation generation processing apparatus 100B and a document output apparatus 200B may be included in one user terminal 300, as shown in FIG. 3. The reason for this is that one user may generate an annotation and check it at the same time.

The document management apparatus 360 includes the annotation storage module 160 and the document storage module 170, and manages documents and annotations used by plural users. The annotation generation processing apparatus 100A, the document output apparatus 200A, and the user terminal 300 may utilize the document management apparatus 360, in which case, they may not necessarily include the annotation storage module 160 and the document storage module 170. By using the annotation storage module 160 and the document storage module 170 within the document management apparatus 360, the annotation generation processing apparatus 100A and the user terminal 300 each generate an annotation, and the document output apparatus 200A and the user terminal 300 each display a document appended with an annotation.

The document management apparatus 350 includes the non-focused portion extracting module 140, the annotation generating module 150, the annotation storage module 160, the document storage module 170, and the document output module 210.

The user terminal 380 includes the microphone 105, the voice recording module 110, the eye-gaze detecting module 115, the focused portion extracting module 120, the focused-position-and-voice matching module 130, the document display module 180, the display device 185, the voice output module 230, and the speaker 235. The user terminal 380 may only have a user interface function and cause the document management apparatus 350 to perform other processing, such as generating annotations.

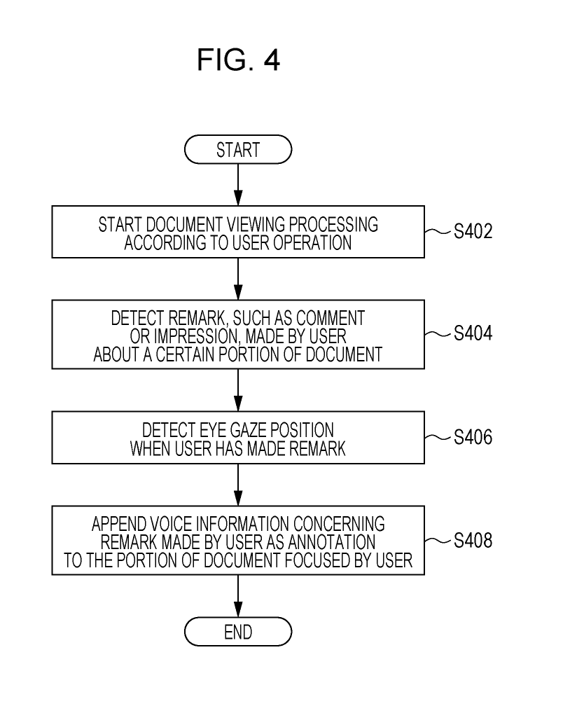

FIG. 4 is a flowchart illustrating an example of processing executed in this exemplary embodiment.

In step S402, the document display module 180 starts document viewing processing according to a user operation.

In step S404, the voice recording module 110 detects a remark, such as a comment or an impression, made by a user about a certain portion of a document. “A remark” is the voice of a user viewing a document. The user makes a remark, such as a comment or an impression, for example, “this is not correct” or “not easy to understand”, about a certain portion of a document. The voice is input by the microphone 105.

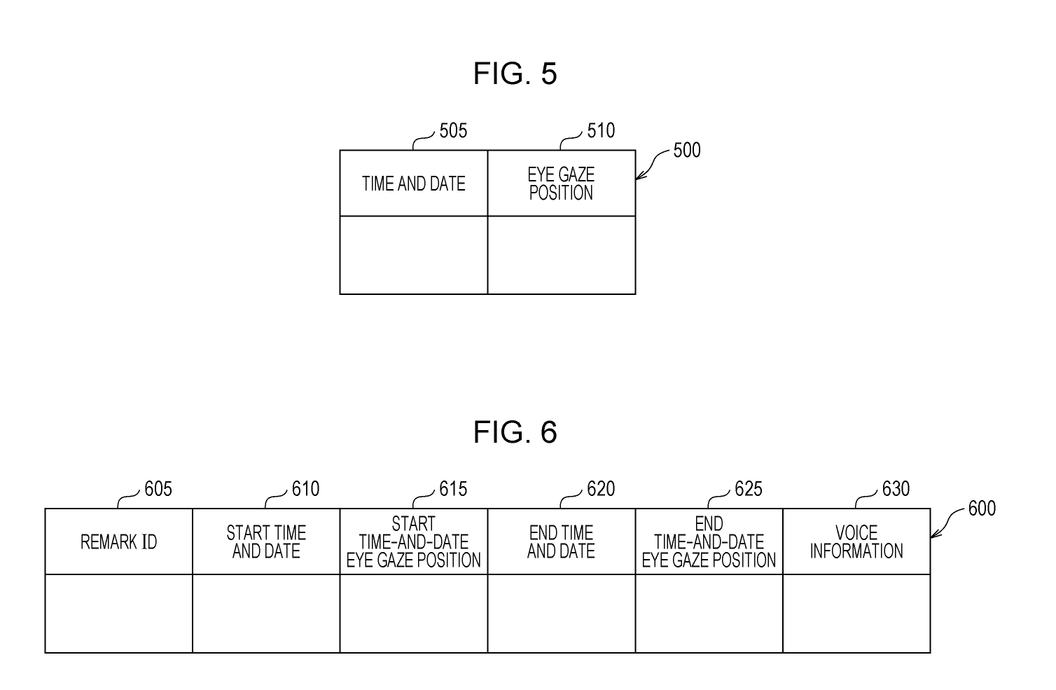

In step S406, the focused portion extracting module 120 detects the position of eye gaze at the time point when the user has made such a remark. The focused portion extracting module 120 generates an eye-gaze information table 500, for example. FIG. 5 illustrates an example of the data structure of the eye-gaze information table 500. The eye-gaze information table 500 includes a time-and-date field 505 and an eye gaze position field 510. In the time-and-date field 505, the time and date at which eye gaze is detected is stored. In the eye gaze position field 510, the eye gaze position at this time and date is stored. In response to detecting of voice, the focused portion extracting module 120 detects the position of eye gaze. Alternatively, after the user has started viewing the document, the focused portion extracting module 120 may continuously detect the eye gaze position and make matching between the user voice and the eye gaze position based on the time and date.

In step S408, the annotation generating module 150 appends voice information concerning the remark made by the user as an annotation to a portion of the document focused by the user. That is, when the user makes a remark, the annotation generating module 150 appends voice information concerning the remark as an annotation to a portion of the document that is being focused by the user. The portion focused by the user may be detected from the eye movement by using a device, such as a head-mounted display, and the voice information recorded by the microphone 105 is associated with a portion of the document (or an object within a document) that is being focused by the user.

More specifically, the focused-position-and-voice matching module 130 matches the eye gaze position and the voice to each other and generates a remark information table 600. FIG. 6 illustrates an example of the data structure of the remark information table 600. The remark information table 600 includes a remark identification (ID) field 605, a start time-and-date field 610, a start time-and-date eye gaze position field 615, an end time-and-date field 620, an end time-and-date eye gaze position field 625, and a voice information field 630. In the remark ID field 605, information (remark ID) for uniquely identifying a remark (voice) in this exemplary embodiment is stored. In the start time-and-date field 610, the time and date at which the user has started to make this remark is stored. In the start time-and-date eye gaze position field 615, the position of eye gaze at this start time and date is stored. In the end time-and-date field 620, the time and date at which the user has finished making this remark is stored. In the end time-and-date eye gaze position field 625, the position of eye gaze at this end time and date is stored. In the voice information field 630, voice information concerning the remark (the content of remark) is stored. Voice recognition results (text) of this voice information may alternatively be stored.

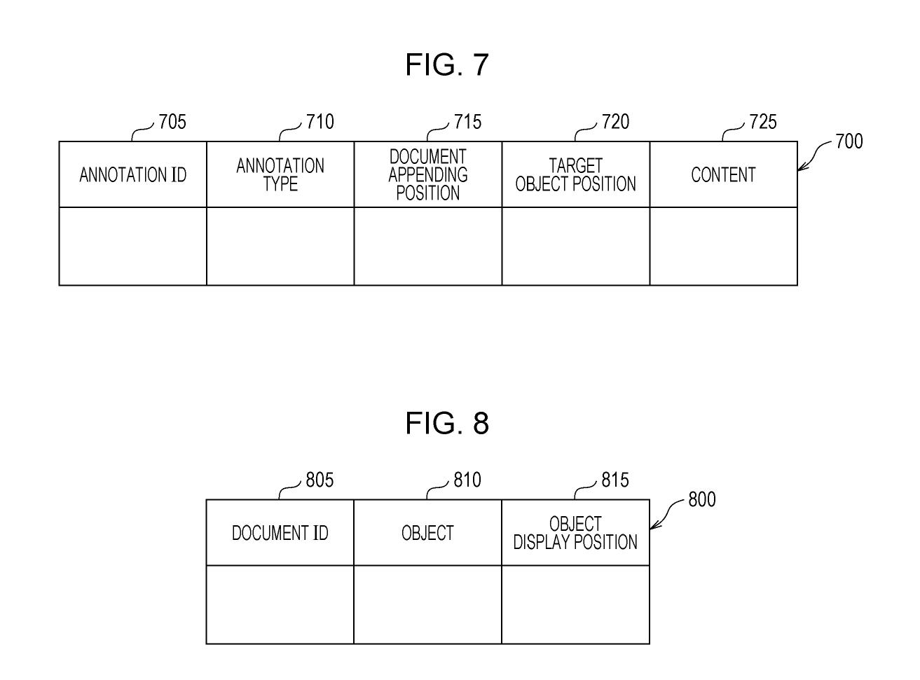

The annotation generating module 150 generates an annotation information table 700. The annotation information table 700 is stored in the annotation storage module 160. FIG. 7 illustrates an example of the data structure of the annotation information table 700. The annotation information table 700 includes an annotation ID field 705, an annotation type field 710, a document appending position field 715, a target object position field 720, and a content field 725. In the annotation ID field 705, information (annotation ID) for uniquely identifying an annotation in this exemplary embodiment is stored. In the annotation type field 710, the type of annotation is stored. In the annotation type field 710, information indicating whether this annotation is an annotation appended to a focused portion or a non-focused portion is stored. Alternatively, a label (ID code) representing that this annotation is voice information or a voice recognition result may be stored. A label representing that this annotation is a comment or an impression may alternatively be stored. It may be possible to identify that this annotation is a comment or an impression by a user operation or by using voice recognition results. If a predetermined word that is likely to be used in comments or impressions is found, the type of annotation may be determined to be a comment or an impression. In the document appending position field 715, the position within a document at which the annotation is appended is stored. In the target object position field 720, the position of a target object to which the annotation is appended is stored. The target object is an object located closest to the position of eye gaze when the user has made a remark. The position of the object is detected by referring to an object display position field 815 of a document object display position information table 800. In the content field 725, the content of this annotation is stored. That is, information similar to that in the voice information field 630 is stored.

The document storage module 170 may store the document object display position information table 800, in addition to documents. FIG. 8 illustrates an example of the data structure of the document object display position information table 800. The document object display position information table 800 includes a document ID field 805, an object field 810, and an object display position field 815. In the document ID field 805, information (document ID) for uniquely identifying a document in this exemplary embodiment is stored. In the object field 810, an object within the document is stored. In the object display position field 815, the display position of the object within the document is stored. By using the value in the object display position field 815, the distance between an eye gaze position and an object is calculated.

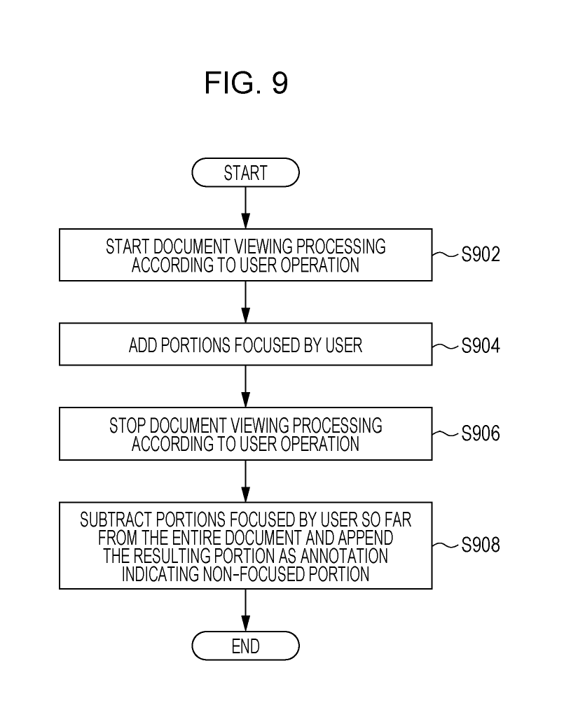

FIG. 9 is a flowchart illustrating an example of processing executed in this exemplary embodiment. More specifically, FIG. 9 illustrates an example of processing for generating an annotation indicating a non-focused portion.

In step S902, document viewing processing starts according to a user operation.

In step S904, portions focused by the user are added together.

In step S906, document viewing processing stops according to a user operation, for example, closing a document.

Instead of steps S902 through S906, steps S402 through S408 in the flowchart of FIG. 4 may be executed.

In step S908, the portions focused by the user so far are subtracted from the entire document, and the resulting region is appended as an annotation indicating that the resulting region is a non-focused portion. As stated above, in addition to a region where no eye gaze has focused, a region where eye gaze has focused during a period shorter than the predetermined period may also be included in the non-focused portion. A non-focused portion may be determined only among regions including objects. That is, a blank region is not regarded as a non-focused portion.

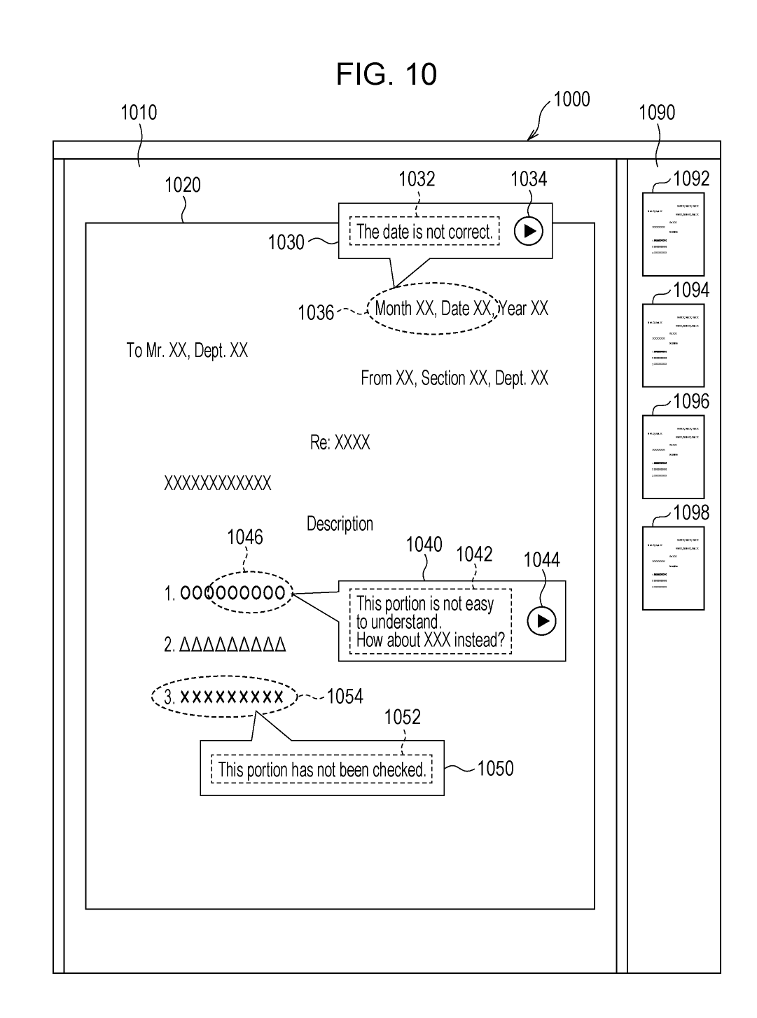

FIG. 10 illustrates a screen for explaining an example of processing executed in this exemplary embodiment (document output apparatus 200). In this example, voice recognition results and voice information are used as annotations, and an annotation indicating that a certain portion is a non-focused portion is appended to an object.

On a screen 1000, a document display region 1010 and a thumbnail document display region 1090 are displayed. In the thumbnail document display region 1090, thumbnail documents 1092, 1094, 1096, and 1098, for example, are displayed. By selecting one of the thumbnail documents in the thumbnail document display region 1090, a document 1020 is displayed in the document display region 1010 on the left side of the screen 1000.

In the document display region 1010, the document 1020 is displayed.

In the document 1020, an annotation 1030 is appended to a target region 1036, an annotation 1040 is appended to a target region 1046, and an annotation 1050 is appended to a target region 1054.

The annotation 1030 has a message region 1032 and a voice output button 1034. The annotation 1040 has a message region 1042 and a voice output button 1044. The annotation 1050 has a message region 1052.

The annotations 1030 and 1040 are annotations generated by the processing indicated by the flowchart in FIG. 4.

The annotation 1050 is an annotation generated by the processing indicated by the flowchart in FIG. 9.

Voice output from a user looking at the target region 1036 can be played back by selecting the voice output button 1034, and the voice recognition result (“the date is not correct”) is displayed in the message region 1032 within the annotation 1030. Voice output from the user looking at the target region 1046 can be played back by selecting the voice output button 1044, and the voice recognition results (“this portion is not easy to understand” and “how about XXX instead?”) is displayed in the message region 1042 within the annotation 1040.

The target region 1054 is a non-focused portion to which the annotation 1050 is appended. Within the message region 1052, a message (“this portion has not been checked”) indicating that the target region 1054 is a non-focused portion is described.

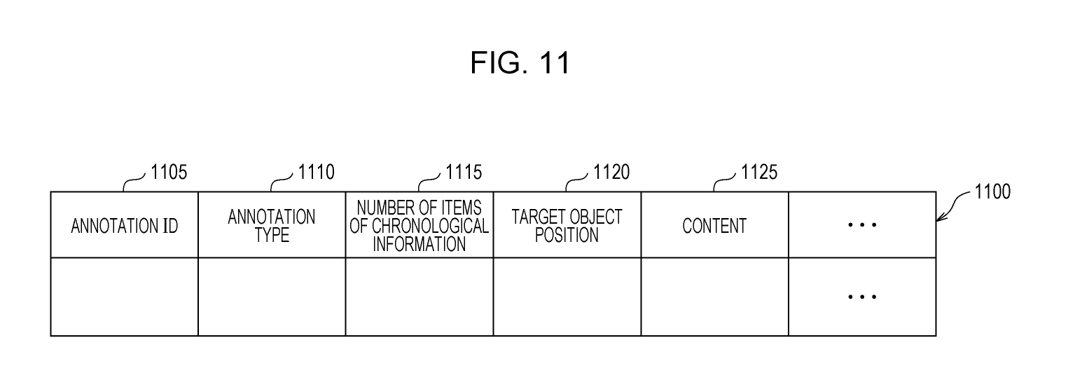

To include chronological information, the annotation information table 700 shown in FIG. 7 may be replaced by an annotation information table 1100. FIG. 11 illustrates an example of the data structure of the annotation information table 1100. The annotation information table 1100 includes an annotation ID field 1105, an annotation type field 1110, a number-of-chronological-information-item field 1115, a target object position field 1120, and a content field 1125. In the annotation ID field 1105, an annotation ID is stored. The annotation ID field 1105 is equivalent to the annotation ID field 705 of the annotation information table 700. In the annotation type field 1110, an annotation type is stored. The annotation type field 1110 is equivalent to the annotation type field 710 of the annotation information table 700. In the number-of-chronological-information-item field 1115, the number of items of chronological information is stored. Then, as many combinations of the target object position field 1120 and the content field 1125 as items of chronological information follow the number-of-chronological-information-item field 1115. The combinations of the target object position field 1120 and the content field 1125 are arranged in chronological order. In the target object position field 1120, the position of a target object is stored. The target object position field 1120 is equivalent to the target object position field 720 of the annotation information table 700. In the content field 1125, the content of annotation is stored. The content field 1125 is equivalent to the content field 725 of the annotation information table 700.

If a user makes plural remarks about the same object (a drawing, a table, or a graph, for example) while shifting eye gaze over the object, these plural remarks can be displayed in chronological order by using one annotation. A specific example will be discussed below with reference to FIG. 12.

FIG. 12 illustrates a screen for explaining an example of processing executed in this exemplary embodiment (document output apparatus 200). In this example, plural remarks are displayed in chronological order by using one annotation.

On a screen 1200, a document display region 1210 and a thumbnail document display region 1290 are displayed. In the thumbnail document display region 1290, thumbnail documents 1292, 1294, 1296, and 1298, for example, are displayed. By selecting one of the thumbnail documents in the thumbnail document display region 1290, a document 1220 is displayed in the document display region 1210 on the left side of the screen 1200.

The document 1220 is displayed in the document display region 1210.

In the document 1220, an annotation 1230 is appended to a graph on the top right (an example of an object). The annotation 1230 has a message region 1232 and a voice output button 1234.

Voice information concerning remarks made by the user about the document 1220 is displayed in synchronization with a chronological change in the portion being viewed by the user. Upon detecting that the voice output button 1234 is selected, the voice of the remarks is output, and the portions being focused by the user when the user has made such remarks (target regions 1242, 1244, and 1246 surrounded by circles in dotted lines, for example) are dynamically displayed. “Being dynamically displayed” means that the portions are displayed in chronological order in synchronization with voice output. While voice “this portion is more XXX” is being output, the target region 1242 and a drawing (balloon drawing) connecting the target region 1242 and the annotation 1230 are displayed. While voice “this portion is ###” is being output, the target region 1244 and a drawing (balloon drawing) connecting the target region 1244 and the annotation 1230 are displayed. While voice “this portion is $$$” is being output, the target region 1246 and a drawing (balloon drawing) connecting the target region 1246 and the annotation 1230 are displayed.

After voice output has finished, the target regions 1242, 1244, and 1246 remain displayed, and reference signs each representing the place in the chronological order (“A” 1236, “B” 1238, and “C” 1240, for example) may be displayed in the individual balloon drawings. These reference signs may be included in the voice recognition results. For example, by inputting the reference signs into parentheses, “this portion (A) is more XXX, this portion (B) is ###, and this portion (C) is $$$” may be displayed. Reference signs representing places in the chronological order and the display order of target regions may be determined by using the time and date of voice output from the user and that of the eye gaze positions.

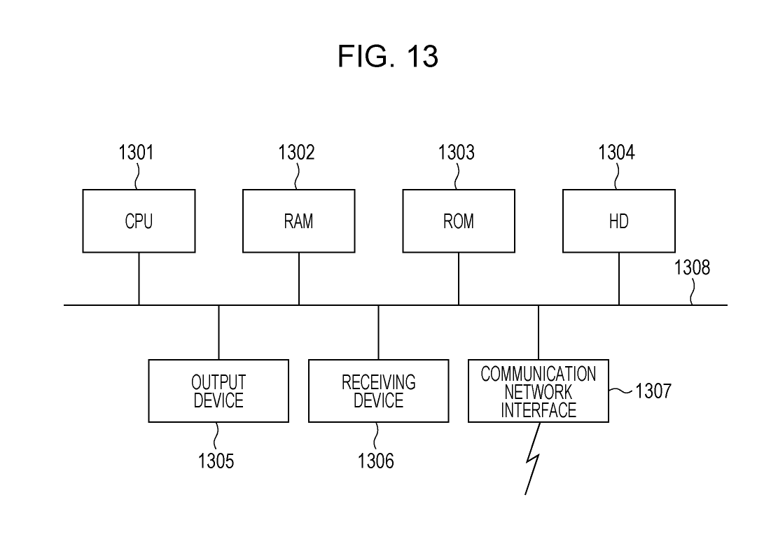

The hardware configuration of a computer which executes a program serving as this exemplary embodiment (the annotation generation processing apparatus 100, the document output apparatus 200, the user terminals 300 and 380, and the document management apparatuses 350 and 360) is a general computer, such as that shown in FIG. 13, and more specifically, a PC or a server. Such a computer uses a CPU 1301 as a processor (operation unit) and a RAM 1302, a read only memory (ROM) 1303, and an HD 1304 as storage devices. As the HD 1304, a hard disk or a solid state drive (SSD) may be used. The computer includes the CPU 1301, the RAM 1302, the ROM 1303, the HD 1304, an output device 1305, a receiving device 1306, a communication network interface 1307, and a bus 1308. The CPU 1301 executes a program implementing the voice recording module 110, the focused portion extracting module 120, the focused-position-and-voice matching module 130, the non-focused portion extracting module 140, the annotation generating module 150, the document display module 180, the document output module 210, the annotation output module 220, and the voice output module 230. The RAM 1302 stores this program and data. The ROM 1303 stores a program for starting the computer, for example. The HD 1304 is an auxiliary storage device (may be a flash memory) having the functions of the annotation storage module 160 and the document storage module 170. The receiving device 1306 receives data, based on operations (including action, voice, eye gaze, etc.) performed by a user on a keyboard, a mouse, a touch screen, the microphone 105, and the eye-gaze detecting module 115. The output device 1305 serves as the speaker 235 and the display device 185, such as a cathode ray tube (CRT) or a liquid crystal display. The communication network interface 1307 is, for example, a network interface card, for communicating with a communication network. The above-described elements are connected to one another via the bus 1308 so that they can send and receive data to and from one another. The above-described computer may be connected to another computer configured similarly to this computer via a network.

In the above-described exemplary embodiment, concerning an element implemented by a computer program, such a computer program, which is software, is read into a system having the hardware configuration shown in FIG. 13, and the above-described exemplary embodiment is implemented in a cooperation of software and hardware resources.

The hardware configuration shown in FIG. 13 is only an example, and the exemplary embodiment may be configured in any manner in which the modules described in this exemplary embodiment are executable. For example, some modules may be configured as dedicated hardware (for example, an application specific integrated circuit (ASIC)), or some modules may be installed in an external system and be connected to the PC via a communication network. Alternatively, a system, such as that shown in FIG. 13, may be connected to a system, such as that shown in FIG. 13, via a communication network, and may be operated in cooperation with each other. Additionally, instead of into a PC, the modules may be integrated into a mobile information communication device (including a cellular phone, a smartphone, a mobile device, and a wearable computer), a home information appliance, a robot, a copying machine, a fax machine, a scanner, a printer, or a multifunction device (image processing apparatus including two or more functions among a scanner, a printer, a copying machine, and a fax machine).

The above-described program may be stored in a recording medium and be provided. The program recorded on a recording medium may be provided via a communication medium. In this case, the above-described program may be implemented as a “non-transitory computer readable medium storing the program therein” in the exemplary embodiment of the invention.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray (registered trademark) disc, a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be the entirety or part of another program, or may be recorded, together with another program, on a recording medium. The program may be divided and recorded on plural recording media. Further, the program may be recorded in any form, for example, it may be compressed or encrypted in a manner such that it can be reconstructed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a matching unit that matches a position of eye gaze of a user within a document to voice output from the user viewing the document at the position of eye gaze; and
a generator that generates an annotation to be appended to a portion of the document located at the position of eye gaze, the annotation indicating the content of the voice.

2. The information processing apparatus according to claim 1, wherein the generator appends an annotation indicating the content of the voice to an object located at the position of eye gaze.

3. The information processing apparatus according to claim 1, wherein the generator generates an annotation indicating the content of a recognition result of the voice.

4. The information processing apparatus according to claim 3, wherein the generator changes a predetermined word included in the recognition result.

5. The information processing apparatus according to claim 1, wherein the generator generates an annotation from which a chronological change in the position of eye gaze is identifiable.

6. The information processing apparatus according to claim 2, wherein the generator generates an annotation from which a chronological change in the position of eye gaze is identifiable.

7. The information processing apparatus according to claim 3, wherein the generator generates an annotation from which a chronological change in the position of eye gaze is identifiable.

8. The information processing apparatus according to claim 4, wherein the generator generates an annotation from which a chronological change in the position of eye gaze is identifiable.

9. The information processing apparatus according to claim 1, wherein the generator generates an annotation to be appended to a portion other than a portion located at the position of eye gaze, the annotation indicating that the portion appended with the annotation is a portion of the document where eye gaze is not focused.

10. The information processing apparatus according to claim 9, wherein the generator appends the annotation to an object located at a portion other than a portion located at the position of eye gaze.

11. An information processing method comprising:
matching a position of eye gaze of a user within a document to voice output from the user viewing the document at the position of eye gaze; and
generating an annotation to be appended to a portion of the document located at the position of eye gaze, the annotation indicating the content of the voice.

12. A non-transitory computer readable medium storing a program causing a computer to execute a process, the process comprising:
matching a position of eye gaze of a user within a document to voice output from the user viewing the document at the position of eye gaze; and
generating an annotation to be appended to a portion of the document located at the position of eye gaze, the annotation indicating the content of the voice.
